(19) United States
(12) Patent Application Publication
(10) Pub. No.: US 2007/0037562 A1
(43) Pub. Date: Feb. 15, 2007

(54) Method and system for call management within a cellular telephone group subscription

(76) Inventors: Penny Lee Smith-Kerker, Austin, TX (US); Arthur James Tysor, Buda, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/201,649

(22) Filed: Aug. 11, 2005

(51) Int. Cl. H04M 3/00

(52) U.S. Cl. 455/418

(57) ABSTRACT

A unique telephone number is assigned to each member within a cellular telephone group subscription and one or more ancillary unique telephone numbers are assigned to subsets of members within the cellular telephone group subscription such that a call directed to an ancillary unique telephone number may be answered by one or more members of the cellular telephone group subscription assigned that particular number. In this manner a unique number may be utilized to contact any member of the cellular telephone group subscription or a selected subset of the members of a cellular telephone group subscription.

### BACKGROUND OF THE INVENTION

1. Technical Field

The present invention relates in general to cellular telephones and in particular to user features of cellular telephones. Still more particularly the present invention relates to a method and system for call management within a cellular telephone group subscription.

2. Description of the Related Art

The utilization of cellular telephones (cell phones) is becoming increasingly popular in today's wireless environment. Cellular phone services provided for both business use and personal use via individual cell phones which connect to particular cellular service providers, such as Sprint, GTE, Verizon, and Cingular.

The popularity of cellular phones has led to a growing desire for improvements in the hardware and software for user satisfaction. Major improvements on the hardware side have included the creation of lightweight phones and the inclusion of advanced features, such as web access, call waiting, caller ID, time display, etc. Some of these features are provided as a menu option which may be enabled or disabled as desired by a particular user.

Cellular services typically provided with a monthly or annual agreement between the subscriber and the cellular service provider. Typically, each cellular subscriber selects a service plan which includes a set number of daytime or peak minutes and another set number of night and weekend, or off peak minutes, in a set period or cycle (usually monthly) for a given price (e.g., 120 minutes peak, 300 off/peak minutes for $29.99). Cell phone users may then select from among a multitude of rate plans, each offering differing amounts of minutes during differing times of the day.

More recently, most cellular service providers have begun to offer so-called “Shared Plans” which are also known as “Family Plans” wherein a number of people share a large pool of minutes under a single calling plan. Since the number of minutes to be utilized by everyone within the plan can be purchased in bulk, the per-minute cost is typically lower than available with individual plans. In addition, typically only one monthly bill is provided and utilized to detail the cost of all included subscribers utilizing this particular type of calling plan. Such plans are ideal for small businesses, work groups, families and organizations.

The availability of such group plans solves many problems; however, there are situations which are unique to such plans. For example, when an emergency situation occurs a user may have to separately dial three or four telephone numbers before reaching a member of the family plan when the user urgently needs to reach any member of that group. Similarly, school or nursing personnel may require contact with either parent in a family situation and, if a single number is provided for one parent and that parent is unavailable, the emergency situation may be exacerbated by the inability of such personnel to contact a parent.

Consequently, it would be useful to provide a method and system whereby a user may selectively attempt to communicate with an entire group of subscribers within a family plan or some subset of those subscribers. The present invention recognizes this need and sets forth a method and system whereby this may be accomplished.

### SUMMARY OF THE INVENTION

It is therefore an object of the invention to provide an improved cellular telephone system. It is another object of the present invention to provide improved user features for a cellular telephone system.

It is yet another object of the present invention to provide an improved method and system for call management within a cellular telephone group subscription.

The foregoing objects are achieved as is now described.

A unique telephone number is assigned to each member within a cellular telephone group subscription and one or more ancillary unique telephone numbers are assigned to subsets of members within the cellular telephone group subscription such that a call directed to an ancillary unique telephone number may be answered by one or more members of the cellular telephone group subscription assigned that particular number. In this manner a unique number may be utilized to contact any member of the cellular telephone group subscription or a selected subset of the members of a cellular telephone group subscription.

These and other benefits are provided by the invention described herein.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high level block diagram of a cellular telephone which may be used to implement the method and system of the present invention;

FIG. 2 is schematic representation of a cellular telephone network with multiple subscribers located therein which may be utilized to implement the method and system of the present invention;

FIG. 3 is a tabular representation of the telephone number scheme utilized with the call management method and system of the present invention; and

FIG. 4 is a high level logic flowchart illustrating the call management method of the present invention.

### DETAILED DESCRIPTION OF AN ILLUSTRATIVE EMBODIMENT

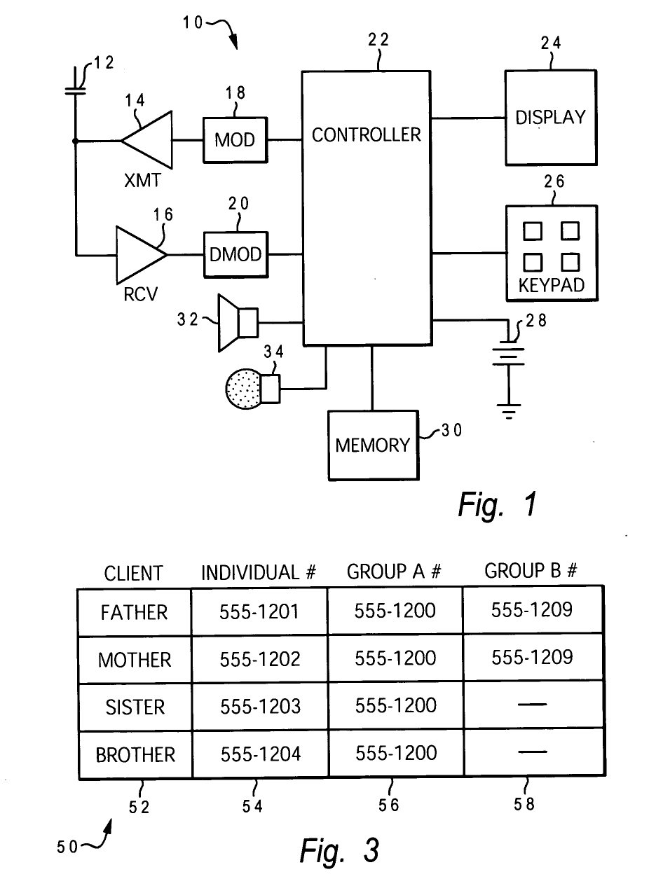

With reference now to the figures and in particular to FIG. 1 there is depicted a high level block diagram of a cellular telephone which may be used to implement the method and system of the present invention. As illustrated, a cellular telephone 10 is depicted. Cellular telephone 10 comprises a cellular radio telephone or personal communicator which may be utilized to practice the present invention. Cellular telephone 10 preferably includes an antenna 12 for transmitting signals to and receiving signals from a base site or base station (not shown). Such a base station may be part of a cellular network comprising a base station/mobil switching center MSC function which, in a manner not necessary for an understanding of the present invention, may be utilized to link cellular telephone 10 to the central office and other subscribers throughout the telephone system.

Cellular telephone 10 includes a transmitter 14 and a receiver 16. Transmitter 14 is coupled to modulator 18 and receiver 16 is coupled to demodulator 20. Modulator 18 and demodulator 20 are coupled to controller 22 which is coupled to speaker 32 and microphone 34. In this manner speech and/or data may be processed within controller 22, modulated via modulator 18 and transmitted via transmitter 14 into the cellular telephone system. Similarly, signals received via antenna 12 may be processed by receiver 16 and demodulator 20 and coupled to controller 22.

The particular interface standard utilized by a cellular telephone 10 is not critical to an understanding of the present invention; however, it is understood that any suitable interface standard may be utilized. Examples of such interface standards include time division multiple access (TDMA) systems, code division multiple access (CDMA) or a global system for mobile communications (GSM) system.

It should also be understood that controller 22 includes all circuitry required for implementing the audio and logic functions of cellular telephone 10. For example, controller 22 may be comprised of a digital signal processor device, a microprocessor device, and various analog to digital converters, digital to analog converters, and other support circuitry. These various circuits may be referred to as “base band” circuits and the control and signal processing functions of cellular telephone 10 are allocated between these devices according to their respective capabilities.

A typical user interface provided with a cellular telephone 10 includes a display 24 which may comprise a liquid crystal display (LED) or other suitable technology. Also provided is a keypad 26 with individual keys which permit the user to enter commands and numbers for operating a cellular telephone 10. A battery 28 is provided and this battery typically is rechargeable and may be recharged utilizing a conventional charging system (not shown) in a manner well known to those having ordinary skill in the art.

Various memory devices 30 are also coupled to controller 22. Those having ordinary skill in the art will appreciate that memory devices 30 may include memory for storing various cellular system parameters, a number assignment module (NAM), user data, including user messages, which are received prior to display to the user, address books and telephone numbers. Memory device 30 is also intended to illustrate the utilization of a subscriber identification module (SIM) which stores a user identity for a particular phone.

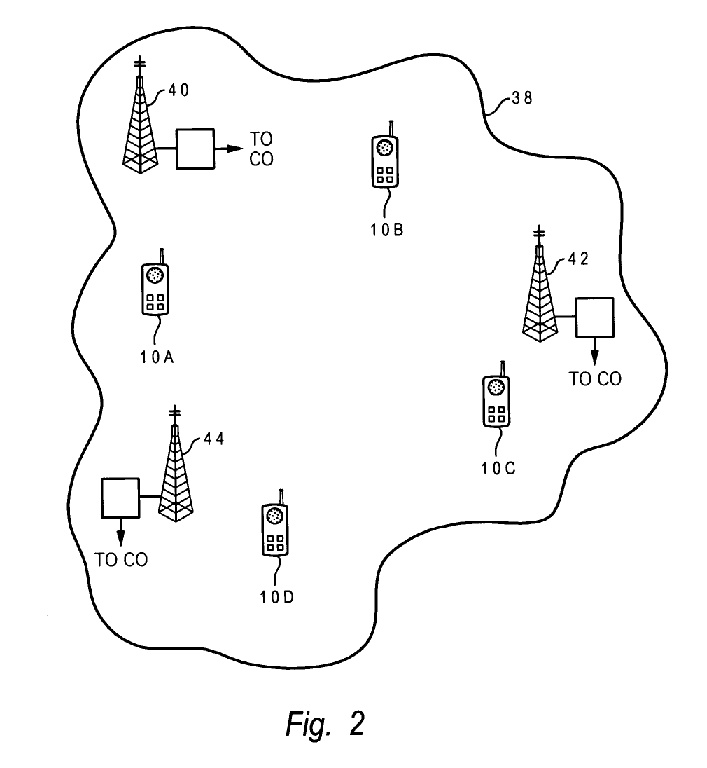

Referring now to FIG. 2 there is depicted a schematic representation of a cellular telephone network 38 with multiple subscribers located therein. As illustrated, a cellular telephone network 38 includes a plurality of base stations such as base station 40, 42, and 44. Each base station preferably includes a mobile switching center and is connected to the telephone central office in a manner conventional to those having ordinary skill in this art.

As illustrated, multiple subscribers, each having a cellular telephone may be dispersed throughout cellular telephone network 38. Thus, cellular telephone 10a, cellular telephone 10b, cellular telephone 10c and cellular telephone 10d may dispersed at various geographic locations within cellular telephone network 38 and may, for purposes of illustration in the present invention, comprise four members of a cellular telephone group subscription.

With reference now to FIG. 3 there is illustrated a tabular representation of the telephone number scheme utilized with the call management method system of the present invention. For purposes of the present illustration it will be assumed that the cellular telephone group subscription comprises a family unit; however, those having ordinary skill in this art will appreciate that a small workgroup, a small business or other organization will also find implementation of the present invention advantageous.

As illustrated within FIG. 3 table 50 includes a client column 52. Within client column 52 are the identities of four clients within the cellular telephone group subscription utilized to illustrate the present invention. For purposes of this illustration the client list comprises “father,” “mother,” “sister,” and “brother.” Of course, those having skill in this art will appreciate that the cellular telephone group subscription may have any number of members in the group, not merely four as illustrated herein.

As illustrated within individual number column 54, each member of the cellular telephone group subscription illustrated herein includes a unique telephone number assigned to that individual, so that the individual may be contacted efficiently and uniquely within the cellular telephone network.

Next, in accordance with an important feature of the present invention, an ancillary unique telephone number is assigned to various members of the cellular telephone group subscription. As depicted within Group A number column 56 each member of the illustrated cellular telephone group subscription is assigned the same number within the Group A number column. Thus, in accordance with an important feature of the present invention, an individual desiring to contact any client within the cellular telephone group subscription can merely dial the number listed within column 56 and that number will ring at each telephone within the cellular telephone group subscription.

This may be accomplished, as those having ordinary skill in the art will appreciate, by assigning secondary numbers to each user within the cellular telephone group subscription utilizing a dual number NAM (number assignment module) or, simply by assigning this number to each member of the group and causing a telephone call to the number within a group A to be forwarded to each member of the cellular telephone group subscription.

In a similar manner Group B number column 58 depicts a second ancillary unique telephone number which is assigned to two members of the cellular telephone group subscription. Thus, the telephone number “555-1209” is assigned to both “father” and “mother” and thus, school personnel, medical personnel or anyone desiring to contact either parental unit in the cellular telephone group subscription depicted as an illustration herein, can dial the number listed within column 58 and that number, either by assignment within the telephone or by forwarding within the telephone system will cause the phone to ring of both parental units within the cellular telephone group subscription. Although only two Group numbers are depicted, those having skill in this art will appreciate that the number of Group numbers utilized is only limited by the capacity of the telephone system and many more Group numbers may be assigned for purposes not illustrated herein.

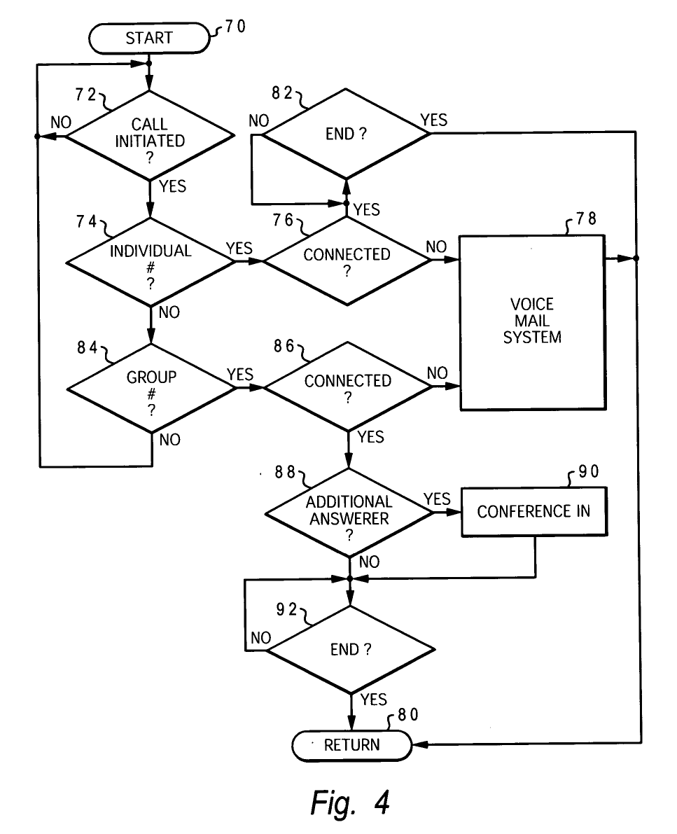

Finally, referring to FIG. 4, there is depicted a high level logic flowchart which illustrates the call management method of the present invention. As illustrated therein, this process begins at block 70 and thereafter, as depicted at block 72, a determination is made as to whether or not a call has been initiated to the cellular telephone group subscription and depicted in FIG. 3. If not, the process iterates until such time as a call has been initiated.

Still referring to block 72, in the event a determination has been made that a call has been initiated the process passes to block 74. Block 74 illustrates a determination of whether or not the call which has been initiated is a call to an individual number. That is, a number listed within individual number column 54 of FIG. 3. If so, the process passes to block 76. Block 76 depicts a determination of whether or not the call was connected and if not, the process passes to voicemail system 78 for the recordation of a voicemail message for the individual desired by the caller. Thereafter, the process passes to block 80 and returns.

Referring again to block 76, in the event the call initiated to an individual number has been connected the process passes to block 82. Block 82 depicts a determination of whether or not that call has terminated and if not, the process iterates until such time as the call has terminated. Once the call has terminated, as illustrated in block 82 the process passes to block 80 and returns.

Referring again to block 74, in the event a call is initiated which is not directed to an individual number the process passes, as depicted in block 74, to block 84. Block 84 illustrates a determination of whether or not the call which has been initiated is to a group number. That is, one of the telephone numbers listed within Group A number column 56 or Group B number column 58. If not, the process returns, in an iterative fashion, to block 72 to await the initiation of a subsequent call.

Still referring to block 84, in the event a call has been initiated which is directed to one of the group telephone numbers depicted within Group A number column 56 or Group B number column 58, the process passes to block 86. Block 86 illustrates a determination of whether or not that call. has been connected. If not, after a suitable delay, the call is connected to voicemail system 78 so that the user may leave a voicemail system in the voice mailbox of each member of the cellular telephone group subscription who is assigned the group number which has been called. Upon completion of that task, as depicted at block 80, the process returns.

Referring again to block 86, in the event a telephone call directed to a group number has been connected, as depicted at block 86, the process passes to block 88. Block 88 illustrates a determination of whether or not an additional person has answered that call. Recall that group numbers are assigned to two or more members of a cellular telephone group subscription and consequently, two or more members of that cellular telephone group subscription may answer a call. In the event this occurs, the process passes from block 88 to block 90 which illustrates the conferencing in of the subsequent answerer and thereafter, or in the event no additional answerer receives the group number, the telephone call the process passes to block 92. Block 92 depicts a determination of whether or not the call, either individually or in conference, has terminated and if not, the process merely iterates until such time as the call has terminated. When the call has terminated, as depicted within block 92, the process passes to block 80 and returns.

Those having ordinary skill in the art upon reference to the foregoing will appreciate that the present invention is directed to a method and system whereby calls may be managed within a cellular telephone group subscription so that a call may be directed to an individual member of the cellular telephone group subscription, a subset of the cellular telephone group subscription or the entire cellular telephone group subscription in an efficient manner which will provide enhanced efficiency within the cellular telephone system.

While the invention has been particularly shown and described with reference to a preferred embodiment, it will be understood by those skilled in the art that various changes in form and detail may be made therein without departing from the spirit and scope of the invention.

What is claimed is:

1. A method for call management within a cellular telephone group subscription, said method comprising the steps of:
assigning a separate unique telephone number to each member within a cellular telephone group subscription; and
assigning an identical ancillary unique telephone number to at least two members within said cellular telephone group subscription wherein a call to said identical ancillary unique telephone number results in transmission of a signal to both of said at least two members for answering by either or both of said at least two members.

2. The method for call management within a cellular telephone group subscription according to claim 1 further including a step of assigning a second identical ancillary unique telephone number to every member within said cellular telephone group subscription wherein a call to said second identical ancillary unique telephone number results in transmission of a signal to all of said members for answering by any or all of said members within said cellular telephone group subscription.

3. A system for call management within a cellular telephone group subscription comprising:
number assignment means for designating a separate unique telephone number for each member of a cellular telephone group subscription;
means for assigning an identical ancillary unique telephone number to at least two members within said cellular telephone group subscription;
call direction means for coupling a call directed to said identical ancillary telephone number to both of said at least two members; and
call completion means for establishing a connection with one of said at least two members in response to an answer by one of said at least two members and for establishing a connection with both of said at least two members in response to an answer by both of said at least two members.

4. The call management system according to claim 3 further including:
means for assigning a second identical ancillary unique telephone number to every member within said cellular telephone group subscription.

5. The call management system according to claim 4 wherein said call direction means comprises means for coupling a call directed to said second identical ancillary telephone number to any or all of said members within said cellular telephone group subscription.
